(19) United States
(12) Patent Application Publication
(10) Pub. No.: US 2003/0154291 A1
(43) Pub. Date: Aug. 14, 2003

(54) Mobile modular computer

(75) Inventors: Kenneth Blair Ocheltree, Ossining, NY (US); Masato Anzai, Tokyo (JP); Nicholas R. Dono, Hopewell Junction, NY (US); Akira Hino, Sagamihara-shi (JP); Toshitaka Imai, Sagamihara-shi (JP); Seiichi Kawano, Sagamihara (JP); Shinsuke Noda, Yamato-shi (JP); Ernest Nelson Mandese, Durham, NC (US); Toshitsugu Mito, Atsugi-City (JP); James Randal Moulic, LaGrange, NY (US); Robert K. Montoye, Austin, TX (US); Robert Stephen Olyha JR., LaGrange, NY (US); Ronald Alan Smith, Wake Forest, NC (US); Hiromi Tanaka, Sagamihara (JP); Kazuhiko Yamazaki, Hiratsuka-city (JP); Yoshihisa Sueta, Zama city (JP); Masatoshi Ishii, Ohmihachiman-shi (JP)

Correspondence Address: Michael J. Buchenhorner Esq., P.A., 1430 Sorolla Avenue, Coral Gables, FL, 33134, US

(73) Assignee: International Business Machines Corporation, Armonk, NY

(21) Appl. No.: 10/323,197

(22) Filed: Dec. 18, 2002

Related U.S. Application Data
(60) Provisional application No. 60/354,346, filed on Feb. 5, 2002.

(51) Int. Cl. G06F 15/16

(52) U.S. Cl. 709/228

(57) ABSTRACT

A modular computer system includes a core unit comprising a processor and a memory; a removable modular accessory; a docking connector for connecting the accessory to the core unit; and one or more subsystems contained within the accessory. The system is partitioned such that any of the cooling, power or input/output subsystems can be disposed within the modular accessory such that these subsystems can be removed from the system by removing the accessory. The core unit by itself is not useful to a user because it lacks power, cooling, or a user interface. The core unit can be connected into any of a variety of accessories and it adapts its functions to the system resources provided by each type of accessory.

### CROSS REFERENCE TO RELATED APPLICATIONS

This application claims priority to U.S. Provisional Patent Application Serial No. 60/354,346, filed Feb. 5, 2002.

### FIELD OF THE INVENTION

The invention disclosed broadly relates to the field of information handling systems, and more particularly relates to the field of mobile computing devices.

### BACKGROUND OF THE INVENTION

Computers are typically designed with a specific size and shape and a given set of input and output devices and connectors. In today's increasingly mobile work force, there is a need for a computing device which can be used in a number of different environments, with multiple interfaces. It is necessary, particularly for those who work in multiple locations or in multiple environments (such as office, car, home or field), to have a computer that is adaptable to different configurations of peripheral devices. There have been attempts to address this need.

U.S. Pat. No. 5,264,992 titled “Modular Computer System Having Self Contained Work Slate Unit Detachably Coupled to Base Unit Including Keyboard” required that the core unit of a detachable system have a display and a processor, which docks in a keyboard accessory unit.

U.S. Pat. No. 5,719,743 titled “Torso Worn Computer Which Can Stand Alone” required both front and back portions of unit and side mounting, adaptable for use as a conventional standalone computer. This computer structure provides a body-worn computer.

U.S. Pat. No. 5,844,824 titled “Hands-Free, Portable Computer and System” is not very general and requires attachment to a user. It is limited to hands-free operation only. The display is hands-free; it utilizes only hands-free activation commands; and requires support of hands-free data transfer.

U.S. Pat. No. 5,948,047 titled “Detachable Computer Structure” requires hands-free activation in mobile mode: audio activation means; brain activation means; eye-tracking means and mixtures thereof; and means for attachment to a user's body.

U.S. Pat. No. 5,999,952 “Core Computer Unit” requires completely enclosing the housing. The core is devoid of peripheral ports and has no removable parts.

U.S. Pat. No. 6,029,183 “Transferable Core Computer” requires: 1) the unit must be completely sealed, 2) no replaceable parts inside, 3) no connectors other than the docking connector, 4) it must have a graphics controller in it, but no I/O devices or I/O connectors other than docking 5) it must plug into a second unit that is always part of a third unit, like a car, airplane, medical test equipment, etc., 6) it must have a mass storage unit, 7) it must not be capable of operating when undocked, and 8) it must not have a display.

U.S. Pat. No. 6,157,533 “Modular Wearable Computer” describes a wearable computer made of air-vented modules including storage, processor, I/O device. The only form factor described here is a body-worn computer, attached to a user.

U.S. Pat. No. 6,262,889 “Insulated Mobile Computer” provides for using the computer battery to insulate a wearable user from the heat of the system. This patent refers to a hands-free body-worn form factor, primarily concerned with heat insulation.

U.S. Pat. No. 6,304,459 “Mobile Computer” provides for hands-free operation and comprises a housing, which is attached to a user. The housing comprises all of the components of a conventional computer and has front, back, top and side sections which are constructed from a heat conducting and dissipating material whereas all of the bottom section is constructed of a heat insulating material. The bottom section is located adjacent to a user's body when the computer is worn. Again, this patent refers to a body-worn form factor only.

Present computer systems may comprise a core unit which can be attached to peripheral devices, such as a monitor and/or keyboard. The behavior of the core unit, with respect to its thermal properties and processing capabilities, does not adapt according to what, if any, devices are attached to the core. Therefore, a unit which is used with only a speech interface accessory will expend the same amount of energy for cooling as a unit with a monitor attached. Since an end user will require computing power in many different situations and environments, it follows that the computer system should be adaptable to its environment, adjusting its processing speed and cooling efforts accordingly.

There is a need for a computer system comprising a core computing unit used in tandem with one of a selection of accessory units which can adapt its thermal settings and energy expenditure to suit its use and environment by recognizing and adapting to the accessory unit with which it is paired. This unit should have the ability to adapt its form factor as well in order to conform to differing uses and environments.

### SUMMARY OF THE INVENTION

Briefly, according to the invention, a core computer unit comprises a processor configured to process information and instructions; and a docking connector for connecting the core computer unit to any of one or more accessories, each comprising an interface for peripheral devices. The processor is further configured to identify the accessory connected to the connector and to adapt its operating mode according to the accessory identified.

Novel aspects of the mobile modular computer include its partitioning of the PC architecture and its adaptability to different usage configurations. The mobile modular computer adapts its behavior depending on the accessory with which it is connected. It automatically identifies accessories and adapts its system, power management, thermal system and application software and user interface behavior depending upon the attached accessory.

### BRIEF DESCRIPTION OF THE DRAWINGS

FIG. 1 is a block diagram of a mobile modular computer system according to the present invention.

FIG. 2 shows a representation of a handheld computer, wherein a system in accordance with the invention can be advantageously used.

FIG. 3 is shows a representation of a laptop computer, wherein a system in accordance with the invention can be advantageously used.

FIG. 4 shows a representation of a desktop computer, wherein a system in accordance with the invention can be advantageously used.

FIG. 5 shows a representation of a speech interface computer, wherein a system in accordance with the invention can be advantageously used.

FIG. 6 shows a representation of a wearable computer, wherein a system in accordance with the invention can be advantageously used.

FIG. 7 is an illustration of the software which runs on the system.

FIG. 8 is a block diagram illustrating a docking operation of the system.

### DESCRIPTION OF PREFERRED EMBODIMENTS

The mobile modular computer introduces a new PC system architecture centered around a small, modular, lightweight, highly portable computing core (approximately 3″×5″×¾″ in size and 9 ounces in weight) that contains the processor, system memory, 3-D graphics, disk drive, operating system software and the computer computing environment for applications and personal data. This is a novel partitioning of the PC architecture in that the 1) power source, 2) I/O connectors, and 3) the thermal dissipation unit (the fan) have been removed from the core unit and placed in the accessory unit. A further novelty of this partitioning of the PC architecture is the partitioned thermal solution that it provides. This means that the part that removes the heat from the computer system is placed in a separate unit from the part that dissipates the heat. The two parts need to connect (dock) together in order to provide a thermal solution. This allows different accessories to have different capacities of thermal dissipation, so that systems which require less performance can have a smaller thermal dissipation unit and thus a smaller size.

This computer core transforms its form factor in seconds into a variety of different form factors, depending on the user's need and/or choice. It could alter its form factor to that of a handheld; a personal computer; a desktop; a laptop; a tablet computer; or a wearable computer with head mount display, to name a few examples. This transformation is easily accomplished by the attachment of different interface accessories to the modular core unit. Once attached, the accessory could easily be removed. While the modular core provides the processor, memory, disk and graphics for the system, the attachable accessories provide the power source, from batteries or an AC source; the fan; the user interface options, such as keyboards, mice, displays, touch screens or speech interfaces; and networking connections.

The modular core architecture allows the same computer core to be used as the basis for a number of different sized devices with different form factors depending on the usage and allows the same data and system configuration to be moved among different accessories. Assume that a user is working at an office, using the desktop form factor, preparing for a presentation in a remote office. This user would disconnect the core unit from the desktop accessory and carry the core unit in a pocket or briefcase to a remote office. Once at the new location, the user connects the core unit into a laptop accessory interface at the remote office, and continues working. All of the pertinent data and applications would be available and unchanged from the first form factor (the desktop). This same user could then disconnect the core unit from the remote office system, place it in a pocket or backpack, travel out to a field location and reattach the core unit to a wearable form factor (perhaps the backpack) and continue working out in the field, possibly while hiking or undertaking any other activity necessitating hands-free activation.

The modular core architecture also allows the system to be easily upgraded or repaired, as either the modular core or an accessory would be changed or repaired, while the other component remains unaffected. This contrasts to other modular units where one part or the other is not modifiable in any way and has to be enclosed in housing such that it could not be altered.

The preferred embodiment of the mobile modular computer core is a PC core unit with processor, memory and storage so that it could be pocket-sized for mobility and could provide the maximum MHz/watt/cc/kg for a PC compatible system. This choice for the core allows systems to be built that span the performance range from mobile to the desktop and would allow for simple transitions from a desktop to a wearable computer or other mobile configurations. This mobile modular core has also been considered as the basis for a server, as it provides processing in a power and thermally efficient design and important considerations for servers are thermal and power management and volume.

The division of the system between a pocket-sized modular core and accessories that provide power, input/output, and communications meets the design objective for a modular system where the usage dependent components are housed in the accessories. The display is in the accessory unit since the display size depends upon user preference and usage mode. The battery or other power source is placed in the accessory unit since the battery size is related to display size and type. The communications are implemented in the accessory unit because the specific communications vary depending upon the environment and could be accomplished using any of Ethernet, Bluetooth, 802.11b, or cellular modem communications. In contrast, standard PC system architecture houses the power source, thermal system, and I/O connectors in the core unit.

Block Diagram of a Mobile Modular Computer System

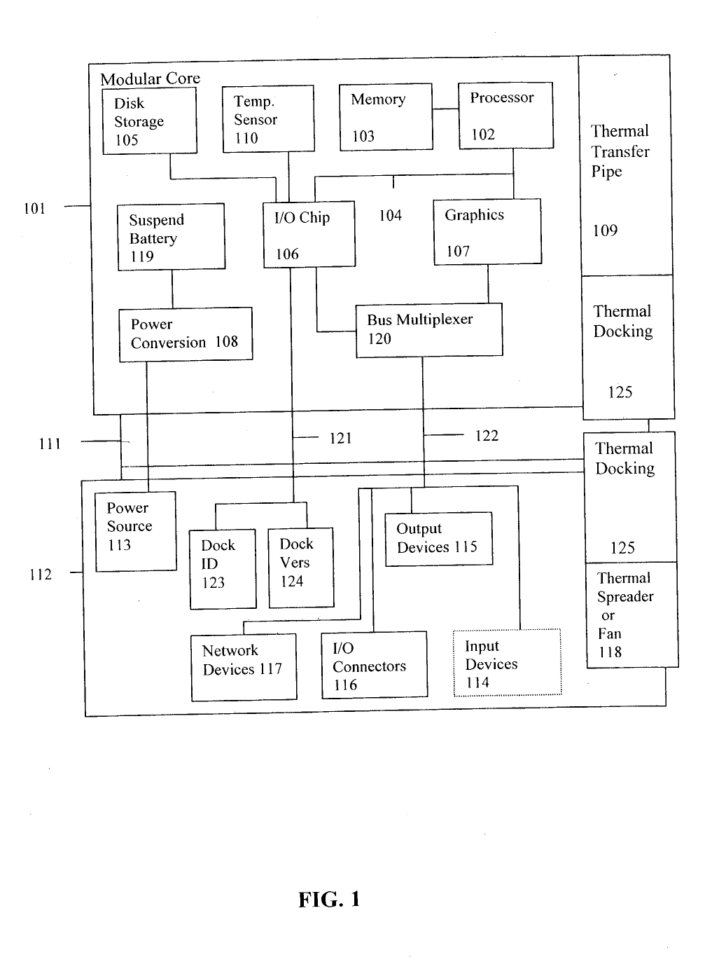

Referring to FIG. 1, there is shown a block diagram of a mobile modular computer system 100 according to an embodiment of the invention. The mobile modular computer system 100 comprises a modular core unit 101 that in turn comprises a processor 102, memory 103, local bus 104, storage 105, I/O chip 106, graphics 107, power supply circuitry 108, suspend battery 119, thermal transfer heat pipe 109, temperature sensor 110, bus multiplexer 120, and a docking connector 111. The docking connector 111 is adapted for identifying accessories that are attached to the modular core unit 101.

A modular accessory 112 is shown attached to the modular core unit 101. The modular accessory 112 includes a power source 113 and optionally contains input devices 114, output devices 115, I/O connectors 116, network devices 117, a thermal spreader 118, a dock ID 123 and a dock version 124. A thermal spreader is a heat pipe or heat sink designed to take the heat away from the modular core unit 101 and spread it over a larger volume. It can be used with a fan or without. It could be a standard heat sink or even a thermally conducting belt that is part of a wearable harness. The contents of the modular accessory 112 allow the modular core unit 101 to adapt itself for different form factors, since different form factors will have different power, cooling and I/O needs. Once connected to the modular accessory 112, the modular core unit 101 will have the same functionality that a user would expect from that particular form factor. The modular accessory 112 can be detached from the core unit 101 and another accessory unit 112 could be attached in its place, thereby converting the system 100 to yet another form factor. The modular accessory 112 will also contain a dock ID 123 and a dock version 124. These two components serve to identify the accessory unit 112 to the modular core 101.

Handheld Computer Form Factor

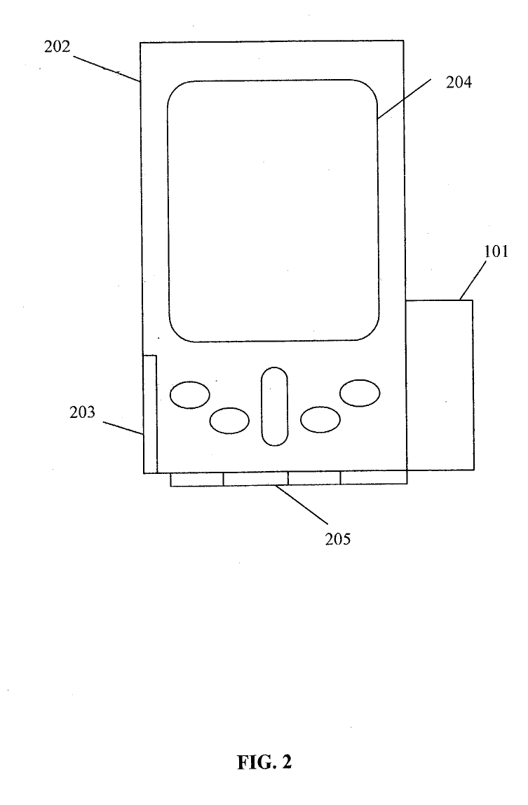

The mobile modular core unit 101 can be used to form a handheld or tablet computer as shown in FIG. 2 by sliding the mobile core unit 101 into the modular accessory 202 that includes a replaceable rechargeable battery 203, a display with a touch screen 204 and I/O connectors 205 for attaching other devices.

Laptop Computer Form Factor

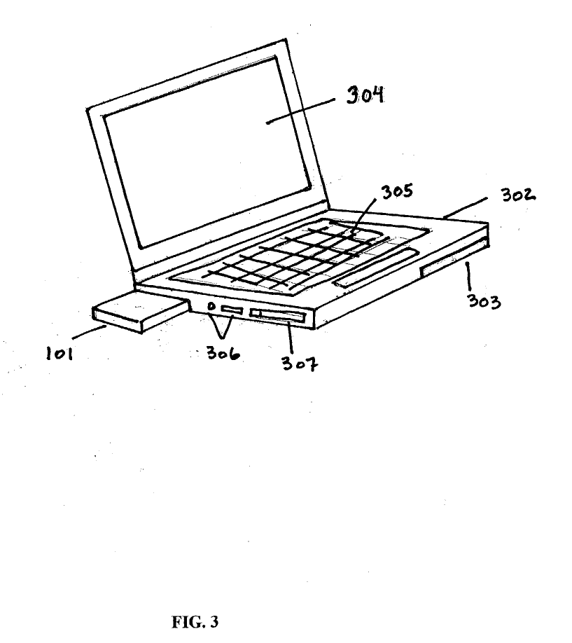

The mobile modular core unit 101 can be used to form a laptop computer as shown in FIG. 3 by sliding the mobile core unit 101 into the modular accessory 302 that includes a replaceable rechargeable battery 303, a display 304 and keyboard 305, and I/O connectors 306 and one or more CardBus slots 307 for attaching other devices.

Desktop Computer Form Factor

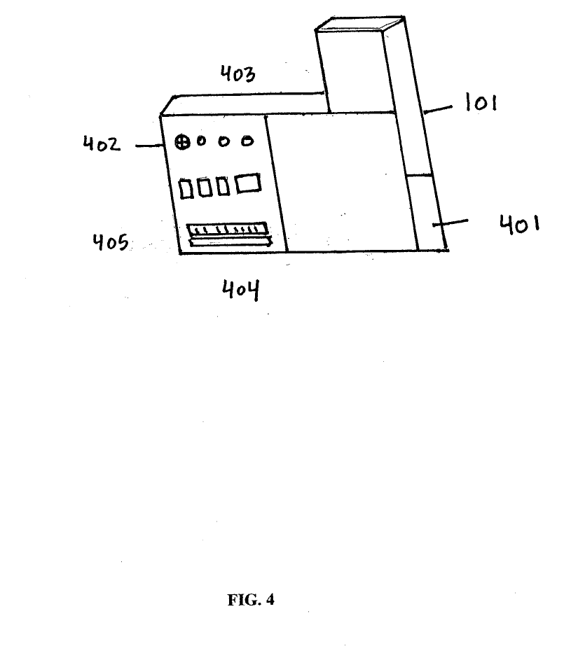

The mobile modular core unit 101 can be used to form a desktop computer as shown in FIG. 4 by sliding the mobile modular core unit 101 into the modular desktop accessory 401 that includes power input 402, IO connectors 403 for display, keyboard, mouse and other I/O devices and one or more CardBus slots 404 for attaching communications and other devices. The desktop dock 401 also contains a fan for providing additional cooling of the modular core unit 101 during operation, with the fan intake 405 visible at the back of the desktop dock. The fan speed is controlled using feedback from the temperature sensor 110 in the modular core unit 101.

Speech Interface Computer Form Factor

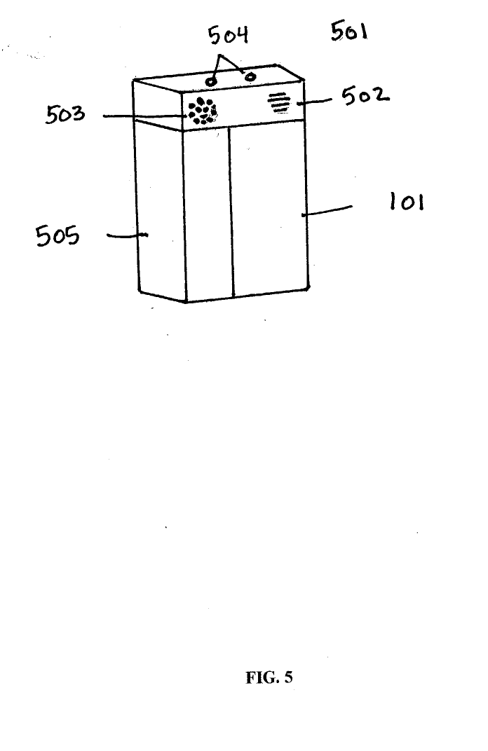

The mobile modular core unit 101 can be used to form a speech interface computer as shown in FIG. 5 by sliding the modular core unit 101 into the modular speech accessory 501 that includes a replaceable rechargeable battery 505 and built-in microphone 502 and speaker 503 or audio input and output connectors 504 for attaching an external microphone and speakers.

Wearable Computer Form Factor

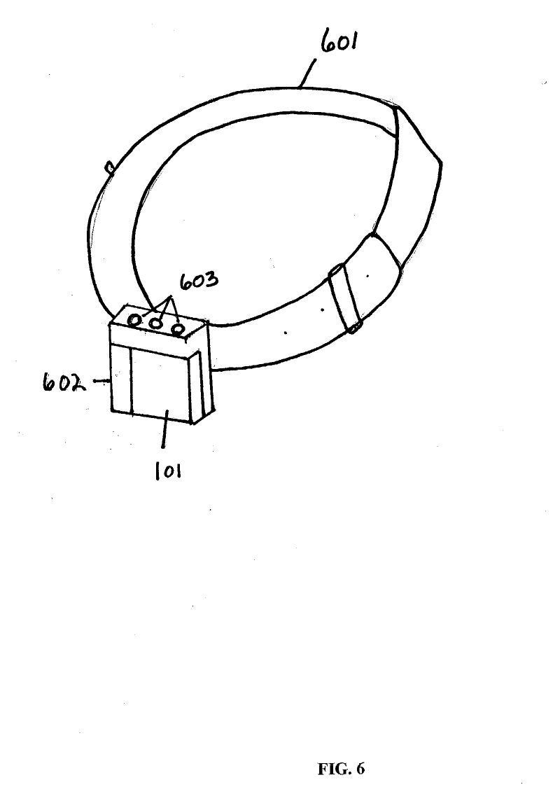

The mobile modular core unit 101 can be used to form a wearable computer as shown in FIG. 6 by sliding the mobile core unit 101 into a wearable belt or shoulder harness 601. The modular wearable accessory 600 includes a replaceable rechargeable battery 602 and input and output connectors 603 for attaching accessories. This represents just one example of an embodiment of this invention. Many adaptations of body-worn computer systems could be envisioned, such as backpacks or headgear.

One unique aspect of the mobile modular computer is its adaptability of form factor with accessories. While the modular core unit 101 contains all parts of the computer system that would stay the same for different computers of different form factors, the accessories, as described above, contain the parts of the system that change with the system form factor including different power sources, either AC line power or batteries, different I/O devices, including keyboards or touch screens, and different communications, including different wireless and wired networks.

Another benefit of this novel partitioning of the PC architecture is its “partitioned thermal solution.” This means that the part that removes the heat from the computer system, usually the thermal spreader 118, is separate from the part that dissipates the heat, the thermal transfer heat pipe 109, and both parts dock together (when the accessory unit 112 is connected to the modular core unit 101 via the docking connector 111). Having a partitioned thermal solution allows different accessories to have different capacities of thermal dissipation, so that systems that require less performance can have a smaller thermal dissipation unit and thus a smaller size. Part of this thermal solution is to provide thermal docking 125, where additional cooling is provided by docking the mobile modular core in an accessory.

The modular core unit 101 can be easily moved between many different accessories 112; therefore it is important that the state information of the system not be lost when the system is being moved among accessories 112. The modular core unit 101 contains a suspend battery 119 that provides sufficient power to maintain the system memory state so that when the core unit 101 is to be moved, the power is first suspended so that the core unit 101 can be moved among systems and resumed in the new system leaving the previously running applications still available.

A key feature necessary for the correct operation of the suspend battery 119 is a mechanical interlock that prevents removal of the modular core unit 101 from an accessory 112 as long as the system is still in the on state and not suspended or off. The purpose of this mechanical interlock feature is to preserve system and data integrity. This feature also assures that the modular core unit 101 will be cool enough to handle in order for removal to be allowed.

Mobile Modular Core Software

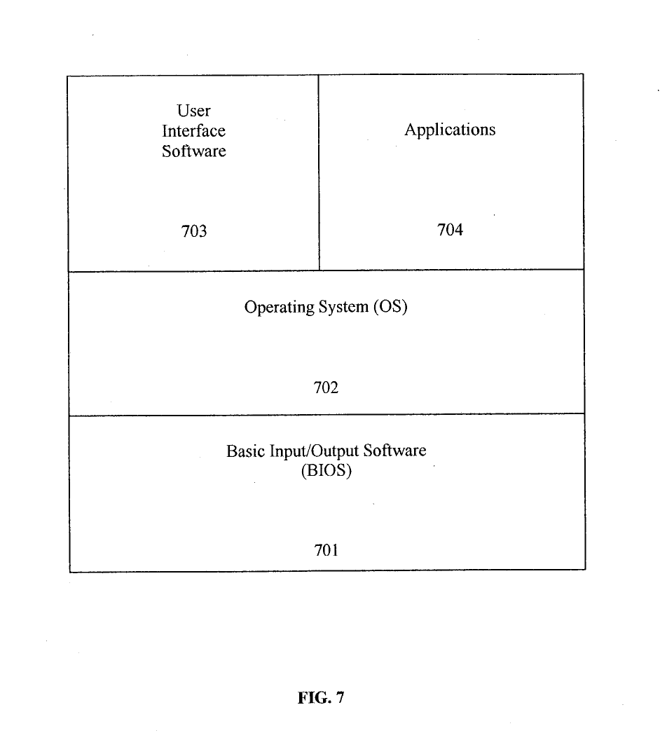

The software that runs on the modular core 101 is shown in FIG. 7 and includes Basic Input Output Software (BIOS) 701, Operating System 702, User Interface Software 703, and Applications 704.

The mobile modular computer docking connector 111 has two groups of signals on the connector as shown in FIG. 1: docking control signals 121 and data signals 122. The data signals 122 coming from the core 101 and the accessory 112 may be routed through a bus multiplexer 120 that determines which sets of signals are passed across the docking connector 111. The first group of docking control signals 121 is used to identify when a reliable connection of the docking connector 111 is achieved. This could be simply accomplished using two pins at each end of the docking connector 111 that loop a signal from the modular core unit 101 through the accessory 112 and back to the modular core unit 101 at the other end of the docking connector 111. This is referred to as the loop back function.

The docking control signals 121 also contain several pins that together communicate the dock ID 123 of the accessory 112 to the modular core unit 101. For example, a docking connector 111 with four pins designated as the dock ID 123 could uniquely identify 16 different attachable accessories. The dock ID 123 could be communicated in other ways, such as serially, as long as the modular core unit 101 is notified of the type of accessory 112 that has been attached. The exchange of the dock ID 123 could also consist of the modular core unit 101 notifying the accessory 112 of the type of core unit 101 that is attached.

The docking control signals 121 could also be used to pass a dock version 124 so that the system's mode of operation is determined by the unit (either the connector 111 or the accessory 112) with the oldest version number. Both ends of the connector 111 must operate connecting the same set of signals based on the same connector version for the docking connector 111 to work properly. If the newer versions of the connector 111 are designed to support all previous versions of the connector 111 to provide backwards compatibility, then whenever two units are connected together with the docking connector 111, the optimal version at which they can operate is that of the modular core unit 101 or accessory 112 with the lowest version number. For example, suppose units designed for version two support both versions one and two modes of operation, and dock version three 124 supports versions one, two, and three modes of operation. If a version two modular core unit 101 is connected to an accessory 112 with the dock version 124 of“two,” then both the modular core unit 101 and the accessory 112 should operate at version two. Likewise, if a version two modular core unit 101 is connected to an accessory 112 with dock version 124 of “three,” they should both operate at version two, the older of the two version.

Docking Operation Process

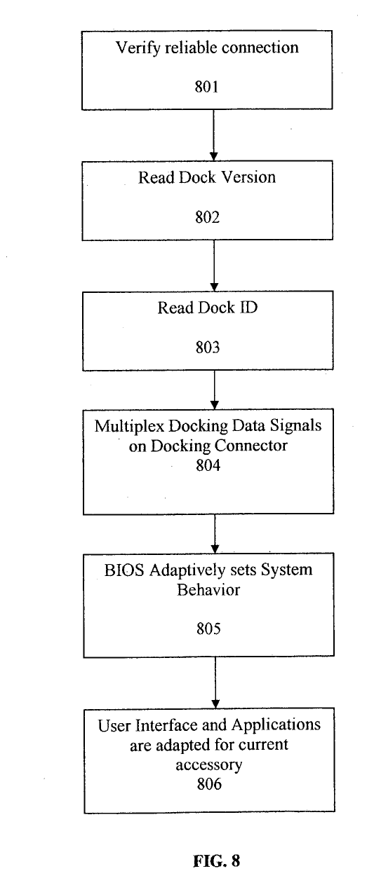

Referring now to FIG. 8 we step through the docking operation process 800. The first step 801 in the docking operation 800, is to verify that the connection has been made. This ensures that a stable power source 113 is connected and that the connector 111 is firmly mated. An example of the full operation of this loopback function is that the modular core 101 receives the power from the accessory 112, converts the power to a 5-volt level using its power supply circuitry 108, and passes the 5-volt signal out of a docking connector pin at one end of the connector 111 and the signal is conditioned upon the accessory 112 being functional and ready for usage and then returned over a pin at the other end of the docking connector 111. This operation on the accessory can further include a selftest on the accessory 112. Thus, this first step in the connection sequence performs a number of functions: 1) ensures that there is a power source 113 connected to the accessory 112; 2) ensures that the docking connector 111 is fully mated between the modular core 101 and the accessory 112 across its length; 3) gives time for the power supply circuitry 108 in the modular core unit 101 to become operational; 4) ensures that the accessory 112 is functional and ready for usage; and 5) allows time for testing of the accessory's 112 functionality. All of these functions can be included or omitted depending upon the specific requirements of the instantiation of this concept.

The second step 802 in the docking operation 800, comprises reading the dock version 124 from the accessory 112. This can either be a separate step or part of reading the dock id number 123 (see step 803).

The third step in the docking operation 800 is reading the dock ID 123 from the accessory 112 in step 803. For example, a docking connector 111 with four pins designated as dock ID 123 could uniquely identify 16 different attached accessories 112. The dock ID 123 could be communicated in other ways, such as serially, as long as the modular core 101 is notified of the type of accessory 112 that has been attached. The exchange of the dock ID 123 can also consist of the modular core 101 notifying the accessory 112 of the type of core unit 101 that is attached. The docking control pins could also be used to pass a docking connector 111 version so that the mode of operation is determined by the connector 111 end with the oldest version number. For this instantiation, we have designated the following dock ID 123 numbers to identify accessories 112:

No accessory attached, dock ID=0

Desktop dock attached, dock ID=1

Handheld accessory attached, dock ID=2

Mini-port replicator attached, dock ID=3

Wearable harness attached, dock ID=4

Tablet accessory attached, dock ID=5

Wireless and battery attached, dock ID=6

Laptop shell attached, dock ID=7

Speech interface accessory attached, dock ID=8

Full desktop accessory, dock ID=9

The fourth step 804 of the docking process, 800, is the multiplexing of signals to the docking connector 111 based on the dock version exchange and optimal version selection. This allows the docking connector 111 to have a number of signal pins equal to the highest number that is needed by any accessory 112 rather than all of the possible signals. For a laptop accessory 112, the docking connector 111 can pass video, audio, multiple USB, and CardBus signals, while for a full desktop system the docking connector 111 can pass the PCI bus, the memory bus or the graphics bus. This feature highlights the adaptability of the docking control signals 121.

The next step in the docking process 800 is step 805 where the dock ID 123 is identified by the BIOS 701 and the system behavior is adapted accordingly. After the BIOS 701 recognizes the dock ID 123 and identifies the attached accessory 112, the BIOS 701 shuts off system components within the modular core unit 101 that are not used in the individual accessory 112 to provide power savings. Examples of this are turning off the graphics controller 107 when no display is attached or turning off the USB controllers when the accessory 112 does not contain any USB ports controlled by the modular core unit 101.

If the dock ID 123 identifies that the connected accessory 112 is one with very little battery resources, then the system configures itself to maximize battery life, including running the processor 102 at the lowest possible speed and running the backlight at low brightness.

If the dock ID 123 identifies that the connected accessory 112 has a fan for cooling, then in step 805 the BIOS 701 configures itself to increase the speed of the fan when the temperature of the modular core unit 101 increases. The fan can optionally run at different speeds depending upon the temperature sensed and hysteresis can be provided to prevent the fan speed from changing too rapidly. Hysteresis means that the fan turns on at a lower temperature from that at which it turns off when the system is cooling down, so that the fan will not as easily be cycling between turning on and off, but will turn on and stay on at the lower possible level. The same feature can be applied to different fan speeds so that the system will not be changing back and forth between two different fan speeds. This problem is due to the higher speed cooling the system so that it goes to the lower temperature which triggers the lower fan speed which does not cool the system sufficiently so that the temperature rises and it goes to the higher fan speed again and the cycle repeats. Hysteresis will cause the system to stay at the higher of the two fan speeds.

The next step in the docking process 800 is the adapting of the system software and applications in step 806. If the dock ID 123 identifies that the system is connected to an accessory 112 with a display, then the system will show the current GUI on the display. If the dock ID 123 identifies that the system has only a speech interface, then a speech recognition program is started and a speech dialog manager is activated to process the speech commands. If the dock ID 123 identifies that the system is a tablet or handheld with a touch and pen interface, then the system starts a touch keyboard and pen stroke recognition software.

The mobile modular computer can also use the docking process 800 to adapt the security used for accessing the system. If the modular core unit 101 is attached to an accessory 112 that is mounted in a public place, such as an airport, then the system will require more security for accessing than when the system is docked in a desktop accessory 112 at the owner's home or office. Security biometrics can also be adapted to match the accessory 112; for example, if only a speech interface is available, then voice recognition will be used to verify the user's access, while other solutions may be available in other accessories 112.

The mobile modular computer comprises adaptive thermal characteristics that include the following. When the modular core unit 101 is carried in the pocket, all logic is suspended and there is no active component inside. The aluminum chassis provides good thermal conductivity for quick cooling and thermal insulation. It is designed such that the CPU 102 and any other “hot” components are away from the planar (motherboard), battery, and disk drive. “Cold” components, such as the suspend battery 119 and memory 103, are placed at the end with the docking connector 111. When the mobile modular computer is used as a handheld as shown in FIG. 2, the CPU speed and power is slowed down, the heat pipe 109 and spreader 118 and the natural air flow from ventilating louvers cools down the CPU 102 to prevent it from burning a user's hands. As a desktop dock, to power up the performance of desktop work, the high pressure air flow from the thermal spreader 118, in conjunction with a fan, provided in the desktop interface accessory 112 makes CPU speed accelerate, the high pressure air blows through the cold side of the heat pipe 109 and the modular core's 101 thermal spreader 118 and thermal diffuser 109 change the air flow inside the modular core unit 101, and the fan speed is controlled to keep the core temperature low while minimizing the acoustic noise.

The mobile modular computer 100 adapts to accessories 112 thermally by measuring the temperature on the temperature sensor 110 in the modular core unit 101 and using that information to control the system performance and the cooling provided. If the system temperature is low, below T1, then the system is allowed to run at full performance and no additional cooling is provided. When the temperature exceeds T1, but is less than T2, additional cooling is provided, such as a fan, if available in the accessory 112. The fan can optionally run at different speeds depending upon the temperature and hysteresis can be provided to prevent the fan speed from changing too rapidly. If no fan is available in the accessory 112, the system could provide cooling by other means, such as a thermal spreader 118 (heat sink or other thermally conducting material), a heat pump or an electrically powered cooler. When the temperature T2 is exceeded, the system performance is then limited, so that the heat produced by the system will be reduced. When a higher temperature T3 is exceeded, the system is forced to suspend or shutdown until the system is sufficiently cooled for operation.

The mobile modular computer 100 uses a partitioned thermal solution that allows the system to adaptively change its thermal and system performance behavior depending upon the attached accessory 112. Part of this thermal solution is to provide thermal docking 125, where additional cooling is provided by docking the mobile modular core unit 101 in an accessory 112.

Therefore, while there has been described what is presently considered to be the preferred embodiments, it will be understood by those skilled in the art that other modifications can be made within the spirit of the invention.

We claim:

1. A core computer unit comprising
a processor configured to process information and instructions; and
a docking connector for connecting the core computer unit to any of one or more accessories, each comprising an interface for peripheral devices;
wherein the processor is further configured to identify the accessory connected to the connector and to adapt its operating mode according to the accessory identified.

2. The core computer unit of claim I wherein the processor is configured to identify the accessory by reading a code provided by the accessory and wherein the code uniquely identifies the accessory.

3. The core computer unit of claim 1 further comprising a thermal docking device activated when the core computer unit is connected to the accessory.

4. The core computer unit of claim 1 further comprising means for adapting the core computer unit's thermal properties according to the accessory identified as connected to the core computer unit.

5. The core computer unit of claim 1 wherein the core computer unit adapts its input or output operation to one or more of the following communication attributes: speech, pen, display size or mounting.

6. The core computer unit of claim 1 wherein the system adapts its power supply behavior according to the accessory identified as connected to the core computer unit.

7. The core computer unit of claim 5 wherein the core computer unit comprises means for adapting its software behavior according to the accessory identified as connected to the core computer unit.

8. The core computer of claim 1 further comprising a multiplexer for multiplexing of signals to the docking connector based on a dock version exchange and optimal version selection.

9. A modular computer system comprising:
a core unit comprising a processor and a memory;
a removable modular accessory;
a docking connector for connecting the accessory to the core unit; and
a cooling subsystem;
the system being partitioned such that the cooling subsystem is disposed within the modular accessory such that the cooling subsystem can be removed from the system by removing the accessory.

10. The system of claim 9 wherein the core unit further comprises a thermal transfer conduit for connecting with the cooling subsystem.

11. The system of claim 9 further comprising a power subsystem for powering the core unit when the accessory is connected to the core unit and wherein the system is partitioned such that the power subsystem is within the accessory.

12. The system of claim 9 wherein the system comprises a graphics subsystem within the core unit.

13. The system of claim 9 wherein the system comprises disk storage within the core unit.

14. The system of claim 9 wherein the system comprises at least one user interface connector, within the accessory, for connecting to one or more peripheral devices.

15. The system of claim 9 wherein the accessory comprises a power subsystem for providing power to the core unit when the core unit is connected to the accessory.

16. The system of claim 9 wherein the system comprises means for adapting its thermal properties according to the accessory connected to the core unit.

17. The system of claim 9 wherein the system comprises means for adapting its cooling properties according to the accessory connected to the core unit.

18. The system of claim 9 wherein the system comprises means for adapting its processor behavior according to the accessory connected to the core unit.

19. The system of claim 9 wherein the system comprises means for adapting its power supply behavior according to the accessory connected to the core unit.

20. The system of claim 9 wherein the system adapts its operation responsive to communication or an identifier from the accessory.

21. The system of claim 9 comprising means for authentication that adapts its operating mode to the accessory connected to the core unit.

22. The system of claim 9 comprising a suspend battery in the core unit and means for adaptively suspending or hibernating depending upon the remaining capacity in the suspend battery.

23. The system of claim 9 wherein the accessory comprises a dock ID for serial transmission over the docking connector.

24. The system of claim 9 wherein the core unit comprises networking circuitry.

25. The system of claim 9 comprising means for thermal docking that is adaptive to the accessory connected to the core unit.

26. The system of claim 9 wherein the core unit comprises a multiplexer for multiplexing of signals to the docking connector based on a dock version exchange and optimal version selection.

27. A modular computer system comprising:
a core unit comprising a processor and a memory;
a removable modular accessory;
a docking connector for connecting the accessory to the core unit; and
a power subsystem;
the system being partitioned such that the power subsystem is disposed within the modular accessory such that the power subsystem can be removed from the system by removing the accessory.

28. A modular computer system comprising:
a core unit comprising a processor and a memory;
a removable modular accessory;
a docking connector for connecting the accessory to the core unit; and
an input/output subsystem;
the system being partitioned such that the cooling subsystem is disposed within the modular accessory such that the input/output subsystem can be removed from the system by removing the accessory.
